(19) United States
(12) Patent Application Publication
(10) Pub. No.: US 2007/0287071 A1
(43) Pub. Date: Dec. 13, 2007

(54) Non-aqueous electrolyte solution for secondary battery and non-aqueous electrolyte secondary battery using the electrolyte solution

(75) Inventors: Takanobu Chiga, Osaka (JP); Yoshinori Kida, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Osaka (JP)

(21) Appl. No.: 11/808,825

(22) Filed: Jun. 13, 2007

(30) Foreign Application Priority Data
Jun. 11, 2006 (JP) 2006-300150
Jun. 14, 2006 (JP) 2006-164188
May 15, 2007 (JP) 2007-129198

(51) Int. Cl. H01M 10/40

(52) U.S. Cl. 429/332; 429/200

(57) ABSTRACT

A non-aqueous electrolyte for a secondary battery includes a solvent and an electrolyte containing a lithium salt. The solvent contains 4-fluoroethylene carbonate and a chain carboxylic ester represented by the formula R₁COOR₂, where R₁ and R₂ are alkyl groups having 3 or less carbon atoms. The amount of the 4-fluoroethylene carbonate is 7 volume % or greater with respect to the total amount of the solvent.

### BACKGROUND OF THE INVENTION

1. Field of the Invention

The present invention relates to performance improvements of non-aqueous electrolyte secondary batteries, and more particularly to a non-aqueous electrolyte for a secondary battery that ensures good electrolyte solution permeability and improves load characteristics and durability of a large-coating-amount and high-filling-density battery. The invention also relates to a non-aqueous electrolyte secondary battery using the non-aqueous electrolyte.

2. Description of Related Art

Mobile information terminals such as mobile telephones, notebook computers, and PDAs have become smaller and lighter at a rapid pace in recent years, and this has led to a demand for higher capacity batteries as the drive power source for the mobile information terminals. Non-aqueous secondary electrolyte batteries that perform charge and discharge by transferring lithium ions between the positive and negative electrodes offer high battery voltage, high energy density, and high capacity. For this reason, the non-aqueous secondary electrolyte batteries have been widely used as the driving power sources for the mobile information terminal devices. Currently, the non-aqueous electrolyte secondary battery commonly employs a lithium-containing transition metal oxide for the positive electrode active material and a graphite-based carbon material for the negative electrode active material. However, the non-aqueous electrolyte secondary batteries with this type of structure do not meet the demand of long-hour operation for recent mobile information terminals sufficiently, and there is an urgent need for higher capacity batteries. In addition, there have been an increasing number of attempts to extend the application area of the non-aqueous electrolyte secondary batteries to power tool applications and automobile applications such as electric automobiles and hybrid automobiles, which require high power. Accordingly, there is a need for a secondary battery that has high power and high durability as well as high capacity.

In order to obtain a higher capacity with the non-aqueous electrolyte secondary battery, it is considered effective to improve the utilization depth of the positive electrode active material by increasing the end-of-charge voltage and to develop alloy-based negative electrodes, such as silicon, that show higher specific capacities than graphite-based carbon materials. Although these have been partially in commercial use, the development of the high-capacity batteries is still largely dependent on the technique of packing the active material into the battery can efficiently, such as increasing the active material applied and increasing the filling density of the active material. This technique, however, may bring about a longer distance from the electrode surface layer to the current collector or less gap spaces within the electrode, resulting in poor electrolyte permeability. This means, in a high-coating-amount, high-filling-density type battery, a higher overvoltage is required for lithium ion diffusion and the load characteristics are sacrificed. Moreover, in a cycle test, the battery is forced to undergo the charge-discharge reactions repeatedly under the condition in which the electrolyte solution does not permeate uniformly, and consequently non-uniform reactions take place between the electrode and the electrolyte solution, resulting in capacity degradation. Furthermore, the time required to fill the electrolyte solution in assembling the battery becomes longer, raising manufacturing costs of the battery.

A more specific discussion now follows from the viewpoint of the types of electrolyte solutions. The state-of-the-art non-aqueous electrolyte secondary batteries commonly use an electrolyte solution in which a lithium salt, such as LiPF₆, and LiBF₄, is dissolved in a mixed solvent of a cyclic carbonic ester, such as ethylene carbonate, and a chain carbonic ester, such as diethyl carbonate, ethyl methyl carbonate, and dimethyl carbonate, and this has successfully achieved good charge-discharge characteristics (see, for example, Japanese Published Unexamined Patent Application No. 5-211070). Nevertheless, the just-described electrolyte solution is difficult to ensure sufficient electrolyte permeability into the electrode and unable to obtain desired battery performance under the circumstances in which a higher capacity battery is strongly desired and the coating amount and the filling density of the electrode increases year after year. Owing to these circumstances, it is essential to develop a non-aqueous electrolyte solution that can bring out desired battery performance with a battery for high-capacity applications.

On the other hand, in order to obtain a high power with the non-aqueous electrolyte secondary battery, attempts have been made to enhance the load characteristics by reducing the filling density and the loading amount of the active material and correspondingly increasing the amount of electrolyte solution in the electrodes. However, if the amount of electrolyte solution is increased by reducing the loading amount and the filling density, the current value increases accordingly. Consequently, the battery faces the situation in which the electrolyte solution does not permeate into the electrodes uniformly, like the case of the above-described attempts to achieve a high capacity battery. Moreover, if the filling density and the loading amount of the active material are reduced, the electrode needs to be longer in order to obtain a desired battery capacity, necessitating an extra length of the separator. Accordingly, in the batteries for high-power applications as well, it is necessary to prevent the separator from having to be made longer by increasing the filling density and the loading amount of the active material to lower the manufacturing cost of the battery. In view of these circumstances, improvements in the electrolyte permeability and enhancement in the load characteristics and durability are desired even with a battery for high-power applications.

Thus, a problem with the conventional electrolyte solution in which a cyclic carbonic ester and a chain carbonic ester are mixed has been that the load characteristics and the durability are degraded and sufficient battery performance cannot be obtained when the conventional electrolyte solution is used for a battery for high-capacity applications or a battery for high-power applications.

### BRIEF SUMMARY OF THE INVENTION

Accordingly, it is an object of the present invention to provide a non-aqueous secondary battery electrolyte that achieves good load characteristics and high durability in a battery for high-capacity applications and high-power applications, and a non-aqueous electrolyte secondary battery employing the electrolyte.

In order to accomplish the foregoing and other objects, the present invention provides a non-aqueous electrolyte for a secondary battery, comprising a solvent and an electrolyte containing a lithium salt, wherein the solvent containing a chain carboxylic ester represented by the formula R₁COOR₂, where R₁ and R₂ are alkyl groups having 3 or less carbon atoms, and 4-fluoroethylene carbonate, and the amount of the 4-fluoroethylene carbonate is 7 volume % or greater with respect to the total amount of the solvent.

### DETAILED DESCRIPTION OF THE INVENTION

The battery that uses the non-aqueous electrolyte solution according to the present invention, which contains 4-fluoroethylene carbonate and a chain carboxylic ester represented by the formula R₁COOR₂, where R₁ and R₂ are alkyl groups having 3 or less carbon atoms, achieves significant improvements in load characteristics and durability. The reasons will be discussed below in two broadly categorized sections, one being the reason for using the chain carboxylic ester represented by the formula R₁COOR₂, where R₁ and R₂ are alkyl groups having 3 or less carbon atoms, and the other being the reason for using 4-fluoroethylene carbonate.

### (1) The Reason for Using the Chain Carboxylic Ester Represented by the Formula R₁COOR₂, where R₁, and R₂ are Alkyl Groups having 3 or Less Carbon Atoms

As described above, the conventional electrolyte solution employs the one in which a cyclic carbonic ester such as ethylene carbonate and a chain carbonic ester are mixed. In this case, the ethylene carbonate is used for the purposes of improving the dissociation performance of the electrolyte and forming a good surface film on the surface of the negative electrode active material, while the chain carbonic ester is used for the purpose of keeping the electrolyte solution a liquid and reducing its viscosity because the ethylene carbonate is in a solid form under room temperature. However, it has been difficult to ensure sufficient electrolyte permeability into an electrode with the conventional electrolyte solution containing the mixture of a cyclic carbonic ester and a chain carbonic ester under the circumstances where the filling density and the loading amount of electrodes have increased year after year as already mentioned above. Nevertheless, even with the battery employing the conventional chain carbonic ester-based electrolyte solution, it is possible to ensure electrolyte permeability to electrodes when dimethyl carbonate, which has a low molecular weight and a low viscosity 0.59 mPas, is contained in the electrolyte solution and the loading amount of the dimethyl carbonate is increased. A problem with dimethyl carbonate, however, is that it has a melting point of 3° C. and therefore results in very poor battery performance at low temperature. Accordingly, in the present invention, attention has been paid to the chain carboxylic ester represented by the formula R₁COOR₂, where R₁ and R₂ are alkyl groups having 3 or less carbon atoms, which is capable of lowering the viscosity of the electrolyte solution and also has a low melting point.

Specifically, such a chain carboxylic ester has a much lower viscosity than the chain carbonic esters that are commonly used. For example, methyl acetate (CH₃COOCH₃), which is one type of the chain carboxylic ester, has a viscosity of 0.37 mPas, which is much lower than the chain carbonic esters that are normally used (for example, the viscosity of diethyl carbonate is 0.75 mPas). Therefore, the viscosity of an electrolyte solution lowers when the chain carboxylic ester is contained in a solvent of the electrolyte solution, making it possible to improve electrolyte permeability to electrodes over the conventional electrolyte solution.

Moreover, such a chain carboxylic ester has a very low melting point. For example, the melting points of methyl acetate and methyl propionate are −98° C. and −88° C., respectively, which are much lower than dimethyl carbonate (melting point: 3° C.) and diethyl carbonate (melting point: −43° C.). Therefore, even when the loading amount of such a chain carboxylic ester is increased in order to lower the viscosity of the electrolyte solution, the performance at low temperature is not sacrificed, unlike dimethyl carbonate.

It should be noted that the reason why R₁ and R₂ in the chain carboxylic ester represented by the formula R₁COOR₂ are restricted to alkyl groups having 3 or less carbon atoms is that when R₁ and R₂ are alkyl groups having 4 or more carbon atoms, the viscosity of the chain carboxylic ester is so high that the advantageous effects of the present invention cannot be exhibited.

### (2) The Reason for Using 4-fluoroethylene carbonate

The reason for using 4-fluoroethylene carbonate is discussed in comparison with the inventions disclosed in Japanese Published Unexamined Patent Application Nos. 5-74487, 5-74490, 8-195221, and 2004-319212 for purposes of clarity of understanding.

These publications propose techniques of improving load characteristics and low-temperature performance by adding a chain carboxylic ester to an electrolyte solution. In these cases, since the chain carboxylic ester generally shows a higher reactivity with graphite-based negative electrode active material than the cyclic carbonic ester, it has been essential to use an ethylene carbonate or a cyclic carbonic ester having C═C unsaturated bonds together with the chain carboxylic ester, in order to suppress the reaction (the foregoing invention is also such an invention). However, when such a composition is employed, capacity degradation resulting from the decomposition of the chain carboxylic ester can be observed as the charge-discharge test is repeated as will be detailed later, although the decomposition reaction of the chain carboxylic ester may be prevented during the initial stage of the charge-discharge test. Although Japanese Published Unexamined Patent Application Nos. 5-74487 and 5-74490 report that good cycle performance can be obtained when ethylene carbonate and methyl propionate are mixed in the solvent, our investigation revealed that ethylene carbonate was inadequate to prevent the decomposition of the chain carboxylic ester, and that the cycle performance was still problematic even with additional use of a cyclic carbonic ester having C═C unsaturated bonds. Probably, a newly formed surface is exposed due to the change in volume of the negative electrode active material associated with charge-discharge operations, causing the addition agent in the electrolyte solution to be continuously consumed, and as a consequence, the addition agent dries out, causing the decomposition of the chain carboxylic ester. The conventional cyclic carbonic ester having C═C unsaturated bonds also has a problem that an excessive amount of the cyclic carbonic ester leads to a thick surface film on the negative electrode, causing a resistance increase and gas formation. Thus, the conventional electrolyte solution composition has not been able to obtain sufficient battery performance even if a chain carboxylic ester is mixed with the electrolyte solution.

In view of the foregoing, we have studied a solvent that functions as a surface-film forming agent for the negative electrode and increasing the loading amount for the purpose of suppressing the reaction between the chain carboxylic ester and the negative electrode active material. As a result, we have found that 4-fluoroethylene carbonate is very effective and that when 4-fluoroethylene carbonate is added to the electrolyte solution in an amount of 7 volume % or more, the reaction between the chain carboxylic ester and the negative electrode active material can be inhibited.

This is because when 4-fluoroethylene carbonate is mixed with the solvent, the 4-fluoroethylene carbonate forms a surface film at a potential nobler than the decomposition potential of the chain carboxylic ester, whereby the decomposition reaction of the chain carboxylic ester is inhibited. In addition, it was confirmed that even when 4-fluoroethylene carbonate was added in an amount of 40 volume % or more with respect to the total amount of the solvent, the battery performance did not degrade considerably. The reason is believed to be that the resistance increase resulting from the increase of the thickness of the surface film on the negative electrode surface is prevented, although the detailed mechanism is not clear. For the reasons stated above, 4-fluoroethylene carbonate can be used as a solvent (that is, unlike the conventional cases, it is not used as an addition agent). Therefore, the problem of the drying out of addition agents does not arise, and good durability can be ensured.

Japanese Published Unexamined Patent Application No. 2004-241339 reports that a secondary battery employing a positive electrode active material LiNi_{0.5}Mn_{1.5}O₄ that intercalates and deintercalates Li at 4.5 V versus metallic lithium or higher can achieve improved cycle performance by using a mixture of a fluorine-substituted carbonate (4-fluoroethylene carbonate) and a chain carboxylic ester (methyl propionate). In the publication however, the loading amounts of both the fluorine-substituted carbonate and the chain carboxylic ester are small, and moreover, the comparative examples show that the cycle performance does not improve when the positive electrode active material is LiMn₂O₄, which shows a positive electrode potential of less than 4.5 V.

In contrast, the present invention employs a chain carboxylic ester for the purposes of lowering the viscosity of the electrolyte solution and making charge-discharge reactions uniform to improve battery cycle performance, and the amount of the 4-fluoroethylene carbonate is restricted to 7 volume % or greater with respect to the total amount of the solvent in order to inhibit the decomposition of the chain carboxylic ester on the negative electrode sufficiently.

In summary, the invention described in the above publication cannot improve the cycle performance of the battery that uses a positive electrode active material having a positive electrode potential of less than 4.5 V in a fully charged state, such as LiCoO₂ or LiMn₂O₄ (nor the above publication does not contain any description about a technique for improving the cycle performance of the battery that uses such a positive electrode active material). In contrast, when the electrolyte solution according to the present invention is used, the cycle performance of the battery that uses such a positive electrode active material can be improved significantly.

### (3) Conclusion

Thus, by using a mixture of a chain carboxylic ester and 4-fluoroethylene carbonate and restricting the loading amount of the 4-fluoroethylene carbonate, the decomposition reaction of the chain carboxylic ester is inhibited, and thereby the advantage of the reduction in the viscosity of the electrolyte solution achieved by a chain carboxylic ester can be maximized. This makes it possible to ensure good permeability of the electrolyte solution even with a battery for high-capacity applications and high-power applications, and to obtain a non-aqueous electrolyte secondary battery that achieves high capacity, high power, and high durability at the same time.

In the present invention, examples of the chain carboxylic esters represented by the formula R₁COOR₂, where R₁ and R₂ are alkyl groups having 3 or less carbon atoms, include methyl acetate [CH₃COOCH₃], ethyl acetate [CH₃COOC₂H₅], n-propyl acetate [CH₃COOCH₂CH₂CH₃], i-propyl acetate [CH₃COOCH(CH₃)CH₃], methyl propionate [C₂H₅COOCH₃], ethyl propionate [C₂H₅COOC₂H₅], n-propyl propionate [C₂H₅COOCH₂CH₂CH₃], i-propyl propionate [C₂H₅COOCH(CH₃)CH₃], methyl n-butyrate [CH₃CH₂CH₂COOCH₃], ethyl n-butyrate [CH₃CH₂CH₂COOC₂H₅], n-propyl n-butyrate [CH₃CH₂CH₂COOCH₂CH₂CH₃], i-propyl n-butyrate [CH₃CH₂CH₂COOCH(CH₃)CH₃], methyl i-butyrate [CH₃(CH₃)CHCOOCH₃], ethyl i-butyrate [CH₃(CH₃)CHCOOC₂H₅], n-propyl i-butyrate [CH₃(CH₃)CHCOOCH₂CH₂CH₃], and i-propyl i-butyrate [CH₃(CH₃)CHCOOCH(CH₃)CH₃].

In order to obtain more desirable load characteristics and durability, chain carboxylic esters having 5 or less carbon atoms are preferable. More specifically, preferable chain carboxylic esters include methyl acetate [CH₃COOCH₃], ethyl acetate [CH₃COOC₂H₅], n-propyl acetate [CH₃COOCH₂CH₂CH₃], i-propyl acetate [CH₃COOCH(CH₃)CH₃], methyl propionate [C₂H₅COOCH₃], ethyl propionate [C₂H₅COOC₂H₅], methyl n-butyrate [CH₃CH₂CH₂COOCH₃], and methyl i-butyrate [CH₃(CH₃)CHCOOCH₃]. Among them, especially preferred are methyl acetate [CH₃COOCH₃], ethyl acetate [CH₃COOC₂H₅], and methyl propionate [C₂H₅COOCH₃], which show low viscosities.

Specifically, the viscosity of methyl acetate [CH₃COOCH₃] is 0.37 mPas, and the viscosities of ethyl acetate [CH₃COOC₂H₅] and methyl propionate [C₂H₅COOCH₃] are 0.44 mPas, and 0.43 mPas, respectively, which are much lower than those of commonly used chain carbonic esters (diethyl carbonate: 0.75 mPas, ethyl methyl carbonate: 0.65 mPas, dimethyl carbonate: 0.59 mPas). Accordingly, by allowing the solvent of the electrolyte solution to contain the chain carboxylic ester such as methyl acetate, the viscosity of the electrolyte solution can be lowered, and therefore, electrolyte permeability to electrodes can be improved.

Furthermore, methyl propionate [C₂H₅COOCH₃] is most preferred among methyl acetate [CH₃COOCH₃], ethyl acetate [CH₃COOC₂H₅], and methyl propionate [C₂H₅COOCH₃]. The reason is that methyl propionate [C₂H₅COOCH₃] shows a lower reactivity with the negative electrode than methyl acetate [CH₃COOCH₃], although methyl propionate [C₂H₅COOCH₃] has a slightly higher viscosity than methyl acetate [CH₃COOCH₃].

It should be noted that the foregoing chain carboxylic esters may of course be used not only alone but also in the form of a mixture thereof.

It is preferable that the amount of the chain carboxylic ester be 20 volume % or greater, more preferably 40 volume % or greater, with respect to the total amount of the solvent.

The reason is that if the content of the chain carboxylic ester falls below these ranges, the viscosity of the electrolyte solution can be so low that the permeability of the electrolyte solution becomes insufficient, which may result in poor load characteristics.

Moreover, it is preferable that the amount of the 4-fluoroethylene carbonate be from 10 volume % to 50 volume %, more preferably from 20 volume % to 40 volume %, with respect to the total amount of the solvent.

If the content of the 4-fluoroethylene carbonate falls below these ranges, the surface film may not be formed sufficiently on the negative electrode surface and desirable durability may not be obtained. On the other hand, if the content of 4-fluoroethylene carbonate exceeds these ranges, the relative content of the chain carboxylic ester reduces correspondingly, and the viscosity of the electrolyte solution increases, causing the permeability of the electrolyte solution to be insufficient. As a consequence, desired load characteristics may not be obtained.

In addition, it is preferable that the solvent contain vinylene carbonate or vinyl ethylene carbonate.

This is preferable because if vinylene carbonate or vinyl ethylene carbonate, one type of the cyclic carbonic esters having C═C unsaturated bonds, is added as a surface-film forming agent for the negative electrode, a good surface film forms on the negative electrode, and it decomposes at a potential nobler than the decomposition potential of the chain carboxylic ester.

It should be noted, however, that examples of the cyclic carbonic esters having unsaturated C═C bonds that may be added as a surface-film forming agent to the negative electrode are not limited to vinylene carbonate and vinyl ethylene carbonate, but include 4,5-dimethyl vinylene carbonate, 4,5-diethyl vinylene carbonate, 4,5-dipropyl vinylene carbonate, 4-ethyl-5-methyl vinylene carbonate, 4-ethyl-5-propyl vinylene carbonate, 4-methyl-5-propyl vinylene carbonate, and divinyl ethylene carbonate. That said, it is preferable to use vinylene carbonate or vinyl ethylene carbonate since a good surface film can be formed when vinylene carbonate or vinyl ethylene carbonate is used.

The foregoing object of the invention may be accomplished by providing a non-aqueous electrolyte secondary battery comprising a positive electrode, a negative electrode, a separator; and a non-aqueous secondary battery electrolyte solution as described above.

The positive electrode active material in the present invention may be a lithium-containing transition metal oxide that has a layered structure or a spinel structure. Particularly preferred is a layered lithium-containing transition metal oxide from the viewpoint of increasing the energy density. Examples of the preferred materials include lithium cobalt oxide, lithium-cobalt-nickel-manganese composite oxide, and lithium-aluminum-nickel-cobalt composite oxide.

These positive electrode active materials may be used either alone or in combination with another positive electrode active material. In addition, when preparing a positive electrode, these materials may be used in a positive electrode mixture with a conductive agent, such as acetylene black or carbon black, and with a binder agent, such as PTFE (polytetrafluoroethylene) or PVdF (polyvinylidene fluoride).

In addition, it is desirable that the positive electrode active material in a fully charged state have a potential of less than 4.5 V versus metallic lithium.

The positive electrode active materials having a layered structure, such as represented by lithium cobalt oxide, is generally charged to about 4.3 V versus metallic lithium, but in the present invention, the positive electrode active material may be charged higher than 4.3 V, more specifically, up to less than 4.5 V, without being restricted to the foregoing voltage. Herein, the reason why the potential of the positive electrode in a fully charged state is restricted to less than 4.5 V versus metallic lithium is as follows. The above-described chain carboxylic ester has a high reactivity with the negative electrode, but it is possible to inhibit the reaction between the chain carboxylic ester and the negative electrode active material by mixing 4-fluoroethylene carbonate into the electrolyte solution. Nevertheless, if the positive electrode potential becomes 4.5 V or higher, the chain carboxylic ester reacts with the positive electrode active material, and when storing the battery at a high temperature, the problem of gas formation arises. Note that when the positive electrode has a configuration such as to be charged near 4.5 V versus metallic lithium and the negative electrode active material employs a graphite-based material, the battery voltage is about 4.4 V.

It is desirable that the positive electrode active material contain lithium cobalt oxide containing aluminum or magnesium in solid solution, and zirconium is firmly adhered to the surface of the lithium cobalt oxide.

The reason for employing such a configuration is as follows. When lithium cobalt oxide is used as the positive electrode active material, the higher the charge depth is, the more unstable the crystal structure tends to be. In view of this problem, aluminum or magnesium is contained in the positive electrode active material (inside the crystals) in the form of solid solution so that crystal strain in the positive electrode can be alleviated. Although these elements serve to stabilize the crystal structure greatly, they bring about degradation in the initial charge-discharge efficiency and decrease in the discharge working voltage. In order to alleviate such a problem, zirconium is made to be firmly adhered on the surface of lithium cobalt oxide.

### Other Embodiments

(1) In addition to the chain carboxylic ester and 4-fluoroethylene carbonate, it is possible to mix any solvent that has conventionally been used for non-aqueous electrolyte secondary batteries with the solvent of the non-aqueous electrolyte solution used in the present invention. Examples of the solvents include: cyclic carbonic esters such as ethylene carbonate, propylene carbonate, 1,2-butylene carbonate, 2,3-butylene carbonate; cyclic esters such as γ-butyrolactone and propane sultone; chain carbonic esters such as diethyl carbonate, ethyl methyl carbonate, and dimethyl carbonate; chain ethers such as 1,2-dimethoxyethane, 1,2-diethoxyethane, diethyl ether, and methyl ethyl ether; tetrahydrofuran; 2-methyltetrahydrofuran; 1,4-dioxane, and acetonitriles.

(2) The solute of the non-aqueous electrolyte solution used in the present invention may be any solute that has conventionally been used for non-aqueous electrolyte secondary batteries. Examples of the electrolytes include lithium salts such as LiPF₆, LiBF₄, LiCF₃SO₃, LiClO₄, LiN(C₂F₅SO₂)₂, LiN(CF₃SO₂)(C₄F₉SO₂), LiC(CF₃SO₂)₃, LiC(C₂F₅SO₂)₃, LiB(C₂O₄)₂, Li[B(C₂O₄)F₂], Li[P(C₂O₄)F₄], and Li[P(C₂O₄)₂F₂]. Among them LiPF₆ is preferred since it has good conductivity. LiBF₄ is also preferable that LiBF₄ itself is involved in the formation process of the surface film in the non-aqueous electrolyte solution and serves to form a good surface film. However, if the loading amount of LiBF₄ is too large, the negative electrode surface film forms excessively, degrading the discharge capacity of the battery. From this viewpoint, it is preferable that LiPF₆ and LiBF₄ are used as a mixture, and especially, it is preferable that in the non-aqueous electrolyte solution, LiPF₆ be contained in an amount of 0.4 mol/L to 1.6 mol/L and LiBF₄ be contained in an amount of 0.05 mol/L to 0.6 mol/L.

(3) Currently, a high-capacity oriented non-aqueous electrolyte secondary battery has the following design. It employs lithium cobalt oxide as the positive electrode active material. The content of the positive electrode active material in the electrode is 92 mass % or greater. The filling density is 3.5 g/cc or higher, and the loading amount of both sides is 400 g/10 cm² or greater. Such a high loading amount and high filling density type battery tends to show insufficient diffusion of the electrolyte solution and suffer from the problems of poor load characteristics and poor durability, and therefore, the battery design thereof is suitable to use the electrolyte solution according to the present invention. The loading amount and filling density at which the advantageous effect becomes noticeable are dependent on the types of active materials, conductive agents, and binder agents as well as the contents thereof, and therefore it is difficult to specify generalized values. That said, the invention is highly effective in a battery design in which the loading amount of both sides of the positive electrode, excluding the mmass of the current collector, is 60xy g/cm² or greater, and the filling density of the positive electrode is 0.60xy g/cc or higher, where the content of the positive electrode active material per mass in the positive electrode is x and the true density is y, for example. In particular, significant improvements in load characteristics and durability become possible when the battery design is such that the loading amount of both sides of the positive electrode is 70xy g/cm² or greater and the filling density of the positive electrode is 0.70xy g/cc or higher.

This means that, with an example a battery in which the positive electrode active material is a layered lithium cobalt oxide (true density: 5.00 g/cc) and the content thereof in the positive electrode is 95 mass % (i.e., when x=0.95 and y=5.00), the invention is highly effective in a battery design in which the loading amount of both sides of the positive electrode is 285 g/10 cm² or greater and the filling density is 2.85 g/cc or higher. In particular, significant improvements in the load characteristics and durability become possible when the battery design of that battery is such that the loading amount of both sides of the positive electrode is 333 g/cm² or greater and the filling density of the positive electrode is 3.33 g/cc or higher.

(4) The negative electrode active material in the present invention may be any material as long as the material is capable of inserting and deinserting lithium. Examples include: metallic lithium; lithium alloys such as lithium-aluminum alloy, lithium-lead alloy, lithium-silicon alloy, and lithium-tin alloy; carbon materials such as graphite, coke, and sintered organic materials; and metal oxides such as SnO₂, SnO, and TiO₂, which show a lower potential than the positive electrode active material. Among them, graphite-based carbon materials are preferred from the viewpoint that a good-quality surface film can be formed on the surface in a non-aqueous electrolyte solution containing 4-fluoroethylene carbonate.

The above-described negative electrode materials may be used in a mixture obtained by kneading a negative electrode material with a binder agent such as PTFE (polytetrafluoroethylene), PVdF (polyvinylidene fluoride), and SBR (styrene-butadiene rubber).

According to the present invention, high capacity and high power can be achieved with a non-aqueous electrolyte secondary battery, and moreover, significant improvements in durability are achieved by using a non-aqueous electrolyte solution that contains 4-fluoroethylene carbonate and a chain carboxylic ester represented by the formula R₁COOR₂, where R₁ and R₂ are alkyl groups having 3 or less carbon atoms, and restricting the amount of the 4-fluoroethylene carbonate.

### Description of the Preferred Embodiments

Hereinbelow, the present invention is described in further detail based on examples thereof. It should be construed, however, that the present invention is not limited to the following examples but various changes and modifications are possible without departing from the scope of the invention.

### Preparation of Positive Electrode

First, lithium cobalt oxide (in which 1.0 mole % of Al and 1.0 mole % of Mg are contained in the form of solid solution and 0.05 mole % of zirconium exists on the surface of the lithium cobalt oxide) as a positive electrode active material, carbon as a conductive agent, and PVDF (polyvinylidene fluoride) as a binder agent were mixed together at a mass ratio of 95:2.5:2.5, and thereafter, the mixture was kneaded in a NMP (N-methyl-2-pyrrolidone) solution, to thus prepare a positive electrode slurry. The resultant positive electrode slurry was applied onto both sides of an aluminum foil current collector in an amount of 520 g/10 cm², and then dried. Thereafter, the resultant material was pressure-rolled so that the positive electrode filling density became 3.7 g/cc. Thus, a positive electrode was prepared.

### Preparation of Negative Electrode

Graphite as a negative electrode active material, SBR (styrene-butadiene rubber) as a binder agent, and CMC (carboxymethylcellulose) as a thickening agent were prepared so that the weight ratio became 97.5:1.5:1, and thereafter the mixture was kneaded in an aqueous solution, to prepare a negative electrode slurry. The resultant negative electrode slurry was applied onto both sides of a copper foil current collector in an amount of 220 g/10 cm², and then dried. Thereafter, the resultant material was pressure-rolled so that the negative electrode filling density became 1.7 g/cc. Thus, a negative electrode was prepared.

### Preparation of Electrolyte Solution

4-fluoroethylene carbonate (FEC) and methyl acetate [CH₃COOCH₃] were mixed at a volume ratio of 20:80, and LiPF₆ as an electrolyte (lithium salt) was dissolved into the solvent at a concentration of 1 mole/L. Thus, a non-aqueous electrolyte solution was prepared.

### Preparation of Battery

The positive electrode and the negative electrode thus prepared were coiled around with a polyethylene separator interposed therebetween to prepare a wound electrode assembly. In a glove box under an argon atmosphere, the resultant wound electrode assembly was enclosed into a battery can together with the above-described electrolyte solution. Thus, a cylindrical 18650 size non-aqueous electrolyte secondary battery was fabricated.

### EXAMPLES

### FIRST GROUP OF EXAMPLES

### Example A1

A non-aqueous electrolyte secondary battery prepared in the manner described in the foregoing preferred embodiment was used for Example A1.

The non-aqueous electrolyte secondary battery fabricated in this manner is hereinafter referred to as Battery A1 of the invention.

### Example A2

A non-aqueous electrolyte secondary battery was fabricated in the same manner as described in Example A1, except that both vinylene carbonate (VC) and vinyl ethylene carbonate (VEC) as addition agents were added in an amount of 2 mass % with respect to the total mass of the solvent and the electrolyte.

The non-aqueous electrolyte secondary battery fabricated in this manner is hereinafter referred to as Battery A2 of the invention.

### Example A3

A non-aqueous electrolyte secondary battery was fabricated in the same manner as described in Example A1, except that the solvent used was a mixture of 4-fluoroethylene carbonate (FEC), ethylene carbonate (EC), and methyl acetate [CH₃COOCH₃] in a volume ratio of 10:10:80.

The non-aqueous electrolyte secondary battery fabricated in this manner is hereinafter referred to as Battery A3 of the invention.

### Example A4

A non-aqueous electrolyte secondary battery was fabricated in the same manner as described in Example A1, except that the solvent used was a mixture of 4-fluoroethylene carbonate (FEC) and methyl acetate [CH₃COOCH₃] in a volume ratio of 40:60.

The non-aqueous electrolyte secondary battery fabricated in this manner is hereinafter referred to as Battery A4 of the invention.

### Example A5

A non-aqueous electrolyte secondary battery was fabricated in the same manner as described in Example A1, except that the solvent used was a mixture of 4-fluoroethylene carbonate (FEC), ethylene carbonate (EC), and methyl acetate [CH₃COOCH₃] in a volume ratio of 20:20:60.

The non-aqueous electrolyte secondary battery fabricated in this manner is hereinafter referred to as Battery A5 of the invention.

### Example A6

A non-aqueous electrolyte secondary battery was fabricated in the same manner as described in Example A1, except that the solvent used was a mixture of 4-fluoroethylene carbonate (FEC), propylene carbonate (PC), and methyl acetate [CH₃COOCH₃] in a volume ratio of 20:20:60.

The non-aqueous electrolyte secondary battery fabricated in this manner is hereinafter referred to as Battery A6 of the invention.

### Example A7

A non-aqueous electrolyte secondary battery was fabricated in the same manner as described in Example A1 above, except that the amount of the electrolyte LiPF₆ was 0.5 mol/L.

The non-aqueous electrolyte secondary battery fabricated in this manner is hereinafter referred to as Battery A7 of the invention.

### Example A8

A non-aqueous electrolyte secondary battery was fabricated in the same manner as described in Example A1 above, except that the amount of the electrolyte LiPF₆ was 1.5 mol/L.

The non-aqueous electrolyte secondary battery fabricated in this manner is hereinafter referred to as Battery A8 of the invention.

### Example A9

A non-aqueous electrolyte secondary battery was fabricated in the same manner as described in Example A1 above, except that LiPF₆ and LiBF₄ were used as the electrolytes, and the amounts of LiPF₆ and LiBF₄ were 0.9 mol/L and 0.1 mol/L, respectively.

The non-aqueous electrolyte secondary battery fabricated in this manner is hereinafter referred to as Battery A9 of the invention.

### Example A10

A non-aqueous electrolyte secondary battery was fabricated in the same manner as described in Example A1 above, except that LiPF₆ and LiBF₄ were used as the electrolytes, and the amounts of LiPF₆ and LiBF₄ were 0.8 mol/L and 0.2 mol/L, respectively.

The non-aqueous electrolyte secondary battery fabricated in this manner is hereinafter referred to as Battery A10 of the invention.

### Example A11

A non-aqueous electrolyte secondary battery was fabricated in the same manner as described in Example A1 above, except that LiPF₆ and LiBF₄ were used as the electrolytes, and the amounts of LiPF₆ and LiBF₄ were both 0.5 mol/L.

The non-aqueous electrolyte secondary battery fabricated in this manner is hereinafter referred to as Battery A11 of the invention.

### Example A12

A non-aqueous electrolyte secondary battery was fabricated in the same manner as described in Example A1 above, except that LiPF₆ and LiB(C₂O₄)₂ were used as the electrolytes, and the amounts of LiPF₆ and LiB(C₂O₄)₂ were 0.9 mol/L and 0.1 mol/L, respectively.

The non-aqueous electrolyte secondary battery fabricated in this manner is hereinafter referred to as Battery A12 of the invention.

### Example A13

A non-aqueous electrolyte secondary battery was fabricated in the same manner as described in Example A1, except that the solvent used was a mixture of 4-fluoroethylene carbonate (FEC) and ethyl acetate [CH₃COOC₂H₅] in a volume ratio of 20:80.

The non-aqueous electrolyte secondary battery fabricated in this manner is hereinafter referred to as Battery A13 of the invention.

### Example A14

A non-aqueous electrolyte secondary battery was fabricated in the same manner as described in Example A1 above, except for the following. The solvent used was a mixture of 4-fluoroethylene carbonate (FEC) and ethyl acetate [CH₃COOC₂H₅] in a volume ratio of 20:80. The electrolytes used were LiPF₆ and LiBF₄, and the amounts of LiPF₆ and LiBF₄ were 1.0 mol/L and 0.2 mol/L, respectively.

The non-aqueous electrolyte secondary battery fabricated in this manner is hereinafter referred to as Battery A14 of the invention.

### Examples A15 to A19

Non-aqueous electrolyte secondary batteries were fabricated in the same manner as described in Example A1, except that the solvents used were mixtures of 4-fluoroethylene carbonate (FEC) and methyl propionate [C₂H₅COOCH₃] in respective volume ratios of 10:90, 20:80, 30:70, 40:60, and 50:50.

The non-aqueous electrolyte secondary batteries thus fabricated are hereinafter referred to as Batteries A15, A16, A17, A18, and A19 of the invention, respectively.

### Example A20

A non-aqueous electrolyte secondary battery was fabricated in the same manner as described in Example A1 above, except for the following. The solvent used was a mixture of 4-fluoroethylene carbonate (FEC) and methyl propionate [C₂H₅COOCH₃] in a volume ratio of 20:80. The electrolytes used were LiPF₆ and LiBF₄, and the amounts of LiPF₆ and LiBF₄ were 1.0 mol/L and 0.2 mol/L, respectively.

The non-aqueous electrolyte example in this manner is hereinafter referred to as Battery A2 of the invention.

### Example A21

A non-aqueous electrolyte secondary battery was fabricated in the same manner as described in Example A1, except that the solvent used was a mixture of 4-fluoroethylene carbonate (FEC) and n-propyl acetate [CH₃COOCH₂CH₂CH₃] in a volume ratio of 20:80.

The non-aqueous electrolyte secondary battery fabricated in this manner is hereinafter referred to as Battery A21 of the invention.

### Example A22

A non-aqueous electrolyte secondary battery was fabricated in the same manner as described in Example A1, except that the solvent used was a mixture of 4-fluoroethylene carbonate (FEC) and i-propyl acetate [CH₃COOCH(CH₃)CH₃] in a volume ratio of 20:80.

The non-aqueous electrolyte secondary battery fabricated in this manner is hereinafter referred to as Battery A22 of the invention.

### Example A23

A non-aqueous electrolyte secondary battery was fabricated in the same manner as described in Example A1, except that the solvent used was a mixture of 4-fluoroethylene carbonate (FEC) and ethyl propionate [C₂H₅COOC₂H₅] in a volume ratio of 20:80.

The non-aqueous electrolyte secondary battery fabricated in this manner is hereinafter referred to as Battery A23 of the invention.

### Example A24

A non-aqueous electrolyte secondary battery was fabricated in the same manner as described in Example A1 above, except that the solvent used was a mixture of 4-fluoroethylene carbonate (FEC) and methyl n-butyrate [CH₃CH₂CH₂COOCH₃] in a volume ratio of 20:80.

The non-aqueous electrolyte secondary battery fabricated in this manner is hereinafter referred to as Battery A24 of the invention.

### Examples A25 to A27

Non-aqueous electrolyte secondary batteries were fabricated in the same manner as described in Example A1, except that the solvents used were mixtures of 4-fluoroethylene carbonate (FEC), dimethyl carbonate (DMC), and methyl propionate [C₂H₅COOCH₃] in respective volume ratios of 20:20:60, 20:40:40, 20:60:20.

The non-aqueous electrolyte secondary batteries thus fabricated are hereinafter referred to as Batteries A25, A26, and A27 of the invention, respectively.

### Comparative Example Z1

A non-aqueous electrolyte secondary battery was fabricated in the same manner as described in Example A1, except that the solvent used was a mixture of ethylene carbonate (EC) and ethyl methyl carbonate (EMC) in a volume ratio of 30:70, and that vinylene carbonate (VC) was added as an addition agent in an amount of 2 mass % with respect to the total mass of the solvent and the electrolyte.

The non-aqueous electrolyte secondary battery fabricated in this manner is hereinafter referred to as Comparative Battery Z1.

### Comparative Example Z2

A non-aqueous electrolyte secondary battery was fabricated in the same manner as described in Comparative Example Z1, except that the solvent used was a mixture of ethylene carbonate (EC), propylene carbonate (PC), and dimethyl carbonate (DMC) in a volume ratio of 35:5:60, and that vinylene carbonate (VC) was added as an addition agent in an amount of 3 mass % with respect to the total mass of the solvent and the electrolyte.

The non-aqueous electrolyte secondary battery fabricated in this manner is hereinafter referred to as Comparative Battery Z2.

### Comparative Example Z3

A non-aqueous electrolyte secondary battery was fabricated in the same manner as described in Comparative Example Z1, except for the following. The solvent used was methyl acetate [CH₃COOCH₃] alone. Both vinylene carbonate (VC) and vinyl ethylene carbonate (VEC) were added as addition agents. The amount of each addition agent was 2 mass % with respect to the total mass of the solvent and the electrolyte.

The non-aqueous electrolyte secondary battery fabricated in this manner is hereinafter referred to as Comparative Battery Z3.

### Comparative Example Z4

A non-aqueous electrolyte secondary battery was fabricated in the same manner as described in Comparative Example Z1, except for the following. The solvent used was methyl acetate [CH₃COOCH₃] alone. Both vinylene carbonate (VC) and vinyl ethylene carbonate (VEC) were used as addition agents. The amount of each addition agent of 4 mass % with respect to the total mass of the solvent and the electrolyte.

The non-aqueous electrolyte secondary battery fabricated in this manner is hereinafter referred to as Comparative Battery Z4.

### Comparative Example Z5

A non-aqueous electrolyte secondary battery was fabricated in the same manner as described in Comparative Example Z1, except for the following. The solvent used was a mixture of ethylene carbonate(EC) and methyl acetate [CH₃COOCH₃] in a volume ratio of 20:80. Both vinylene carbonate (VC) and vinyl ethylene carbonate (VEC) were used as addition agents, and the amount of each of the addition agents was 2 mass % with respect to the total mass of the solvent and the electrolyte.

The non-aqueous electrolyte secondary battery fabricated in this manner is hereinafter referred to as Comparative Battery Z5.

### Comparative Example Z6

A non-aqueous electrolyte secondary battery was fabricated in the same manner as described in Comparative Example Z1, except for the following. The solvent used was a mixture of ethylene carbonate (EC) and ethyl acetate [CH₃COOC₂H₅] in a volume ratio of 20:80. Both vinylene carbonate (VC) and vinyl ethylene carbonate (VEC) were used as addition agents, and the amount of each of the addition agents was 2 mass % with respect to the total mass of the solvent and the electrolyte.

The non-aqueous electrolyte secondary battery fabricated in this manner is hereinafter referred to as Comparative Battery Z6.

### Comparative Example Z7

A non-aqueous electrolyte secondary battery was fabricated in the same manner as described in Comparative Example Z1, except for the following. The solvent used was a mixture of ethylene carbonate (EC) and methyl propionate [C₂H₅COOCH₃] in a volume ratio of 20:80. Both vinylene carbonate (VC) and vinyl ethylene carbonate (VEC) were used as addition agents, and the amount of each of the addition agents was 2 mass % with respect to the total mass of the solvent and the electrolyte.

The non-aqueous electrolyte secondary battery fabricated in this manner is hereinafter referred to as Comparative Battery Z7.

### Comparative Example Z8

A non-aqueous electrolyte secondary battery was fabricated in the same manner as described in Comparative Example Z1, except that the solvent used was a mixture of 4-fluoroethylene carbonate (FEC) and ethyl methyl carbonate (EMC) in a volume ratio of 20:80, and that no addition agent was added.

The non-aqueous electrolyte secondary battery fabricated in this manner is hereinafter referred to as Comparative Battery Z8.

### Comparative Example Z9

A non-aqueous electrolyte secondary battery was fabricated in the same manner as described in Comparative Example Z1, except for the following. The solvent used was a mixture of 4-fluoroethylene carbonate (FEC) and ethyl methyl carbonate (EMC) in a volume ratio of 20:80. The electrolytes used were LiPF₆ and LiBF₄, and the amounts of LiPF₆ and LiBF₄ were 1.0 mol/L and 0.2 mol/L, respectively. No additive agent was added.

The non-aqueous electrolyte secondary battery fabricated in this manner is hereinafter referred to as Comparative Battery Z9.

### Comparative Example Z10

A non-aqueous electrolyte secondary battery was fabricated in the same manner as described in Comparative Example Z1, except that the solvent used was a mixture of 4-fluoroethylene carbonate (FEC) and methyl propionate [C₂H₅COOCH₃] in a volume ratio of 5:95.

The non-aqueous electrolyte secondary battery fabricated in this manner is hereinafter referred to as Comparative Battery Z10.

### Experiment 1

The load characteristics were examined for each of Batteries A1 to A27 and Comparative Batteries Z1 to Z10. The results are shown in Tables 1 to 4 below. In Tables 1 to 4, the discharge capacity of each battery is indicated by a relative number to the discharge capacity of Comparative Battery Z1 when discharged at a current of 0.2It, which was taken as 100.

### Charge-Discharge Conditions

Charge Conditions

Each of the batteries was charged at a constant current of 0.2It until the battery voltage reached 4.2 V and thereafter charged at a constant voltage of 4.2 V until the current value reached 0.02It.

Discharge Conditions

The batteries were discharged at current rates of 0.2It and 2.0 It until the battery voltage reached 2.75 V. Then, during this discharge process, the discharge capacity at 0.2It and the discharge capacity at 2.0It were measured.

The charging and discharging were carried out at 25° C.

TABLE 1

| | | | Addition | Discharge | |
|---|---|---|---|---|---|
| | Lithium salt | Solvent | agent | capacity | |
| Battery | (amount) | (volume. ratio) | (amount) | 0.2It | 2.0It |
| A1 | LiPF₆ | FEC/MA | — | 100 | 99 |
| | (1.0 mol/L) | (20/80) | | | |
| A2 | | | VC (2 | 101 | 100 |
| | | | mass %) + | | |
| | | | VEC (2 | | |
| | | | mass %) | | |
| A3 | | FEC/EC/MA | — | 100 | 99 |
| | | (10/10/80) | | | |
| A4 | | FEC/MA | — | 100 | 99 |
| | | (40/60) | | | |
| A5 | | FEC/EC/MA | — | 100 | 98 |
| | | (20/20/60) | | | |
| A6 | | FEC/PC/MA | — | 99 | 97 |
| | | (20/20/60) | | | |
| A7 | LiPF₆ | FEC/MA | — | 99 | 98 |
| | (0.5 mol/L) | (20/80) | | | |
| A8 | LiPF₆ | | — | 99 | 99 |
| | (1.5 mol/L) | | | | |
| A9 | LiPF₆ | | — | 100 | 99 |
| | (0.9 mol/L) | | | | |
| | LiBF₄ | | | | |
| | (0.1 mol/L) | | | | |
| A10 | LiPF₆ | | — | 99 | 98 |
| | (0.8 mol/L) | | | | |
| | LiBF₄ | | | | |
| | (0.2 mol/L) | | | | |

Note:
FEC: 4-fluoroethylene carbonate,
MA: methyl acetate
EC: ethylene carbonate
PC: propylene carbonate
VC: vinylene carbonate
VEC: vinyl ethylene carbonate

TABLE 2

| | | | Addition | Discharge | |
|---|---|---|---|---|---|
| | Lithium salt | Solvent | agent | capacity | |
| Battery | (amount) | (volume. ratio) | (amount) | 0.2It | 2.0It |
| A11 | LiPF₆ | FEC/MA | — | 96 | 96 |
| | (0.5 mol/L) | (20/80) | | | |
| | LiBF₄ | | | | |
| | (0.5 mol/L) | | | | |
| A12 | LiPF₆ | | — | 100 | 99 |
| | (0.9 mol/L) | | | | |
| | LiB | | | | |
| | (C₂O₄)₂ | | | | |
| | (0.1 mol/L) | | | | |
| A13 | LiPF₆ | FEC/EA | — | 100 | 99 |
| | (1.0 mol/L) | (20/80) | | | |
| A14 | LiPF₆ | | — | 99 | 99 |
| | (1.0 mol/L) | | | | |
| | LiBF₄ | | | | |
| | (0.2 mol/L) | | | | |
| A15 | LiPF₆ | FEC/MP | — | 99 | 98 |
| | (1.0 mol/L) | (10/90) | | | |
| A16 | | FEC/MP | — | 101 | 100 |
| | | (20/80) | | | |
| A17 | | FEC/MP | — | 100 | 98 |
| | | (30/70) | | | |
| A18 | | FEC/MP | — | 99 | 97 |
| | | (40/60) | | | |
| A19 | | FEC/MP | — | 99 | 95 |
| | | (50/50) | | | |
| A20 | LiPF₆ | FEC/MP | — | 99 | 98 |
| | (1.0 mol/L) | (20/80) | | | |
| | LiBF₄ | | | | |
| | (0.2 mol/L) | | | | |

Note:
FEC: 4-fluoroethylene carbonate,
MA: methyl acetate
EA: ethyl acetate
MP: methyl propionate

TABLE 3

| | | | Addition | Discharge | |
|---|---|---|---|---|---|
| | Lithium salt | Solvent | agent | capacity | |
| Battery | (amount) | (volume. ratio) | (amount) | 0.2It | 2.0It |
| A21 | LiPF₆ | FEC/n-PA | — | 100 | 98 |
| | (1.0 mol/L) | (20/80) | | | |
| A22 | | FEC/i-PA | — | 100 | 98 |
| | | (20/80) | | | |
| A23 | | FEC/EP | — | 100 | 98 |
| | | (20/80) | | | |
| A24 | | FEC/n-MB | — | 99 | 97 |
| | | (20/80) | | | |
| A25 | | FEC/DMC/MP | | 100 | 97 |
| | | (20/60/20) | | | |
| A26 | | FEC/DMC/MP | | 100 | 98 |
| | | (20/40/40) | | | |
| A27 | | FEC/DMC/MP | | 100 | 98 |
| | | (20/20/60) | | | |

Note:
FEC: 4-fluoroethylene carbonate,
n-PA: n-propyl acetate
i-PA: i-propyl acetate
EP: ethyl propionate
n-MB: methyl n-butyrate
DMC: dimethyl carbonate
MP: methyl propionate

TABLE 4

| | | | Addition | Discharge | |
|---|---|---|---|---|---|
| Bat- | Lithium salt | Solvent | agent | capacity | |
| tery | (amount) | (volume. ratio) | (amount) | 0.2It | 2.0It |
| Z1 | LiPF₆ | EC/EMC | VC | 100 | 95 |
| | (1.0 mol/L) | (30/70) | (2 mass %) | | |
| Z2 | | EC/PC/DMC | VC | 100 | 95 |
| | | (35/5/60) | (3 mass %) | | |
| Z3 | | MA | VC | 99 | 96 |
| | | (100) | (2 mass %) + VEC | | |
| | | | (2 mass %) | | |
| Z4 | | | VC | 97 | 96 |
| | | | (4 mass %) + VEC | | |
| | | | (4 mass %) | | |
| Z5 | | EC/MA | VC | 100 | 97 |
| | | (20/80) | (2 mass %) + VEC | | |
| | | | (2 mass %) | | |
| Z6 | | EC/EA | VC | 98 | 97 |
| | | (20/80) | (2 mass %) + VEC | | |
| | | | (2 mass %) | | |
| Z7 | | EC/MP | VC | 99 | 97 |
| | | (20/80) | (2 mass %) + VEC | | |
| | | | (2 mass %) | | |
| Z8 | | FEC/EMC | — | 97 | 94 |
| | | (20/80) | | | |
| Z9 | LiPF₆ | FEC/EMC | — | 98 | 95 |
| | (1.0 mol/L) | (20/80) | | | |
| | LiBF₄ | | | | |
| | (0.2 mol/L) | | | | |
| Z10 | LiPF₆ | FEC/MP | — | 96 | 86 |
| | (1.0 mol/L) | (5/95) | | | |

Note:
EC: ethylene carbonate
EMC: ethyl methyl carbonate
PC: propylene carbonate
DMC: dimethyl carbonate
MA: methyl acetate
FEC: 4-fluoroethylene carbonate
EA: ethyl acetate
MP: methyl propionate
VC: vinylene carbonate
VEC: vinyl ethylene carbonate

The results shown in Tables 1 to 4 clearly demonstrate the following. Each of Batteries A1 to A27 of the invention contains the chain carboxylic ester(s) and 4-fluoroethylene carbonate (FEC) as the solvents of the electrolyte solution, while Comparative Batteries Z1 and Z2 contain, as the solvent of the electrolyte solution, a mixture of ethylene carbonate (EC) and ethyl methyl carbonate (EMC), and a mixture of EC and propylene carbonate (PC) and dimethyl carbonate (DMC), respectively (i.e., the solvent comprises cyclic carbonic ester and chain carbonic ester, like the conventional electrolyte solution), and Comparative Batteries Z8 and Z9 contain FEC and EMC (i.e., the solvent comprises a fluorine-substituted carbonate and chain carbonic ester). When the batteries were discharged at a current rate of 0.2It, little difference was observed between Batteries of the invention and Comparative Batteries, but when they were discharged at a current rate of 2.0It, Batteries A1 to A27 of the invention exhibited discharge capacities either the same level as or higher than those of Comparative Batteries Z1, Z2, Z8, and Z9. The reason is believed to be as follows. Since Batteries A1 to A27 of the invention contain a chain carboxylic ester, which has a low viscosity, in the solvent of the electrolyte solution, the electrolyte solution permeates to the region near the current collector more easily than Comparative Batteries Z1, Z2, Z8, and Z9, which contain a carbonate-based solvent in the electrolyte solution. As a result, the overvoltage required for lithium ion diffusion is lowered.

It should be noted that since Comparative Batteries Z3 to Z7 contain a chain carboxylic ester in the solvent of the electrolyte solution, they exhibit higher discharge capacities than Comparative Batteries Z1 and Z2 when discharged at a current rate of 2.0It. This is believed to be due to the same reason as described above.

When comparing Batteries A1, A13, A16, and A21 to A24 of the invention (Note that these batteries are similar in that the lithium salt used is LiPF₆ alone, the solvent contains FEC, and no addition agent is added. In other words, only the types of the chain carboxylic esters are different.), Batteries A1, A13, and A16 showed slightly higher discharge capacities than Batteries A21 to A24, when discharged at a current rate of 2.0It. The reason is believed to be as follows. The chain carboxylic esters used in Batteries A1, A13, and A16 of the invention, methyl acetate (MA), ethyl acetate (EA), and methyl propionate (MP) have lower viscosities than the chain carboxylic esters used in Batteries A21 to A24, n-propyl acetate (n-PA), i-propyl acetate (i-PA), ethyl propionate (EP), and methyl n-butyrate (n-MB). Therefore, the chain carboxylic esters used in Batteries A1, A13, and A16 can lower the viscosity of the electrolyte solution further, and as a result, the permeability of the electrolyte solution into the electrode can be improved further.

When comparing Batteries A15 to A19 of the invention with Comparative Battery Z10 (Note that these batteries are similar in that the lithium salt used is LiPF₆ alone, the solvent contains FEC and MP, and no addition agent is added. In other words, only the volume ratios of the solvent mixtures are different.) Batteries A15 to A19, in which the amount of FEC with respect to the total amount of the solvent (hereinafter also simply referred to as “the amount of FEC”) is 10-50 volume %, showed higher discharge capacities than Comparative Battery Z10, in which the amount of FEC is 5 volume %. Therefore, it is believed that FEC need to be contained in an amount of 7 volume % or more, more desirably 10 volume % or more, in order to obtain desirable discharge load characteristics.

On the other hand, Battery A19, in which the amount of FEC is 50 volume %, showed a slightly lower discharge load characteristic than those of Batteries A15 to A18, in which the amount of FEC is from 10 volume % to 40 volume %. In addition, although not shown in Tables 1 to 4, when the amount of FEC exceeds 50 volume %, the discharge load characteristics degrade further. Therefore, it is preferable that the upper limit of the amount of FEC be restricted to 50 volume % or less, more preferably 40 volume % or less. This is because if the amount of FEC is too large, the viscosity of the electrolyte solution will increase, because FEC has a higher viscosity than chain carboxylic esters.

### Experiment 2

The durability (capacity retention ratio) of each of Batteries A1 to A27 and Comparative Batteries Z1 to Z10 was examined through the charge-discharge tests under the following conditions. The results are shown in Tables 5 to 8 below.

### Charge-Discharge Conditions

(I) First Cycle

Charge Conditions

Each of the batteries was charged at a constant current of 0.2It until the battery voltage reached 4.2 V and thereafter charged at a constant voltage of 4.2 V until the current value reached 0.02It.

Discharge Conditions

The batteries were discharged at a current rate of 0.2It until the battery voltage reached 2.75 V. The initial charge-discharge capacity D₁ of each of the batteries was measured during the discharge.

The charging and discharging were carried out at 25° C.

(II) Second Cycle and Onward

Charge Conditions

Each of the batteries was charged at a constant current of 1.0It until the battery voltage reached 4.2 V and thereafter charged at a constant voltage of 4.2 V until the current value reached 0.02It.

Discharge Conditions

The batteries were discharged at a current rate of 1.0It until the battery voltage reached 2.75 V. During this discharge process, the discharge capacity Dₙ (in the present experiment, n=100 and 200) at the n-th cycle was measured.

The charging and discharging were carried out at 25° C.

Then, from the discharge capacity Dₙ after the n-th cycle (in the present experiment, n=100 and 200) and the initial discharge capacity D₁, the capacity retention ratio (%) after the n-th cycle was obtained according to the following equation (1). For the batteries whose capacity retention ratios fell below 70% during the cycle test, the test was stopped at that point.

Capacity retention ratio (%)=(Dₙ/D₁)×100 (1)

For Batteries A1, A10, A13, A14, A16, and A20 to A23 of the invention, and Comparative Battery Z1, the tests were carried out to 500 cycles.

TABLE 5

| | | | | Capacity retention ration | | | | |
|---|---|---|---|---|---|---|---|---|
| | Lithium | | Addition | (%) | | | | |
| | salt | Solvent | agent | 100th | 200th | 300th | 400th | 500th |
| Battery | (amount) | (Volume ratio) | (amount) | cycle | cycle | cycle | cycle | cycle |
| A1 | LiPF₆ | FEC/MA | — | 93 | 89 | 85 | 82 | 75 |
| A2 | (1.0 mol/L) | (20/80) | VC | 94 | 90 | — | — | — |
| | | | (2 mass %) + VEC | | | | | |
| | | | (2 mass %) | | | | | |
| A3 | | FEC/EC/MA | — | 92 | 88 | — | — | — |
| | | (10/10/80) | | | | | | |
| A4 | | FEC/MA | — | 93 | 88 | — | — | — |
| | | (40/60) | | | | | | |
| A5 | | FEC/EC/MA | — | 91 | 86 | — | — | — |
| | | (20/20/60) | | | | | | |
| A6 | | FEC/PC/MA | — | 91 | 85 | — | — | — |
| | | (20/20/60) | | | | | | |
| A7 | LiPF₆ | FEC/MA | — | 92 | 87 | — | — | — |
| | (0.5 mol/L) | (20/80) | | | | | | |
| A8 | LiPF₆ | | — | 94 | 90 | — | — | — |
| | (1.5 mol/L) | | | | | | | |
| A9 | LiPF₆ | | — | 95 | 90 | — | — | — |
| | (0.9 mol/L) | | | | | | | |
| | LiBF₄ | | | | | | | |
| | (0.1 mol/L) | | | | | | | |
| A10 | LiPF₆ | | — | 95 | 90 | 87 | 84 | 81 |
| | (0.8 mol/L) | | | | | | | |
| | LiBF₄ | | | | | | | |
| | (0.2 mol/L) | | | | | | | |

Note:
FEC: 4-fluoroethylene carbonate
MA: methyl acetate
EC: ethylene carbonate
PC: propylene carbonate
VC: vinylene carbonate
VEC: vinyl ethylene carbonate

TABLE 6

| | | | | Capacity retention ration | | | | |
|---|---|---|---|---|---|---|---|---|
| | Lithium | | Addition | (%) | | | | |
| | salt | Solvent | agent | 100th | 200th | 300th | 400th | 500th |
| Battery | (amount) | (Volume ratio) | (amount) | cycle | cycle | cycle | cycle | cycle |
| A11 | LiPF₆ | FEC/MA | — | 94 | 91 | — | — | — |
| | (0.5 mol/L) | (20/80) | | | | | | |
| | LiBF₄ | | | | | | | |
| | (0.5 mol/L) | | | | | | | |
| A12 | LiPF₆ | | — | 95 | 90 | — | — | — |
| | (0.9 mol/L) | | | | | | | |
| | LiB | | | | | | | |
| | (C₂O₄)₂ | | | | | | | |
| | (0.1 mol/L) | | | | | | | |
| A13 | LiPF₆ | FEC/EA | — | 93 | 88 | 83 | 79 | x |
| | (0.1 mol/L) | (20/80) | | | | | | |
| A14 | LiPF₆ | | — | 94 | 90 | 87 | 84 | 81 |
| | (1.0 mol/L) | | | | | | | |
| | LiBF₄ | | | | | | | |
| | (0.2 mol/L) | | | | | | | |
| A15 | LiPF₆ | FEC/MP | — | 93 | 85 | — | — | — |
| | (1.0 mol/L) | (10/90) | | | | | | |
| A16 | | FEC/MP | — | 94 | 89 | 86 | 82 | 79 |
| | | (20/80) | | | | | | |
| A17 | | FEC/MP | — | 93 | 88 | — | — | — |
| | | (30/70) | | | | | | |
| A18 | | FEC/MP | — | 93 | 88 | — | — | — |
| | | (40/60) | | | | | | |
| A19 | | FEC/MP | — | 93 | 88 | — | — | — |
| | | (50/50) | | | | | | |
| A20 | LiPF₆ | FEC/MP | — | 93 | 90 | 86 | 82 | 80 |
| | (1.0 mol/L) | (20/80) | | | | | | |
| | LiBF₄ | | | | | | | |
| | (0.2 mol/L) | | | | | | | |

Note:
FEC: 4-fluoroethylene carbonate,
MA: methyl acetate
EA: ethyl acetate
MP: methyl propionate
x: Battery whose capacity retention ratio fell below 70% before the end of the cycle test.

TABLE 7

| | | | | Capacity retention ration | | | | |
|---|---|---|---|---|---|---|---|---|
| | Lithium | | Addition | (%) | | | | |
| | salt | Solvent | agent | 100th | 200th | 300th | 400th | 500th |
| Battery | (amount) | (Volume ratio) | (amount) | cycle | cycle | cycle | cycle | cycle |
| A21 | LiPF₆ | FEC/n-PA | — | 91 | 82 | 79 | 76 | 74 |
| | (1.0 mol/L) | (20/80) | | | | | | |
| A22 | | FEC/i-PA | — | 93 | 88 | 84 | 80 | 77 |
| | | (20/80) | | | | | | |
| A23 | | FEC/EP | — | 93 | 86 | 82 | 79 | 77 |
| | | (20/80) | | | | | | |
| A24 | | FEC/n-MB | — | 93 | 87 | — | — | — |
| | | (20/80) | | | | | | |
| A25 | | FEC/DMC/MP | — | 93 | 83 | — | — | — |
| | | (20/60/20) | | | | | | |
| A26 | | FEC/DMC/MP | — | 94 | 85 | — | — | — |
| | | (20/40/40) | | | | | | |
| A27 | | FEC/DMC/MP | — | 94 | 87 | — | — | — |
| | | (20/20/60) | | | | | | |

Note:
FEC: 4-fluoroethylene carbonate,
n-PA: n-propyl acetate
i-PA: i-propyl acetate
EP: ethyl propionate
n-MB: methyl n-butyrate
DMC: dimethyl carbonate
MP: methyl propionate

TABLE 8

| | | | | Capacity retention ration | | | | |
|---|---|---|---|---|---|---|---|---|
| | Lithium | | Addition | (%) | | | | |
| | salt | Solvent | agent | 100th | 200th | 300th | 400th | 500th |
| Battery | (amount) | (Volume ratio) | (amount) | cycle | cycle | cycle | cycle | cycle |
| Z1 | LiPF₆ | EC/EMC | VC | 88 | 79 | x | x | x |
| | (1.0 mol/L) | (30/70) | (2 mass %) | | | | | |
| Z2 | | EC/PC/DMC | VC | 87 | 77 | — | — | — |
| | | (35/5/60) | (3 mass %) | | | | | |
| Z3 | | MA | VC | x | x | — | — | — |
| | | (100) | (2 mass %) + VEC | | | | | |
| | | | (2 mass %) | | | | | |
| Z4 | | | VC | x | x | — | — | — |
| | | | (4 mass %) + VEC | | | | | |
| | | | (4 mass %) | | | | | |
| Z5 | | EC/MA | VC | 77 | x | — | — | — |
| | | (20/80) | (2 mass %) + VEC | | | | | |
| | | | (2 mass %) | | | | | |
| Z6 | | EC/EA | VC | 76 | x | — | — | — |
| | | (20/80) | (2 mass %) + VEC | | | | | |
| | | | (2 mass %) | | | | | |
| Z7 | | EC/MP | VC | 80 | x | — | — | — |
| | | (20/80) | (2 mass %) + VEC | | | | | |
| | | | (2 mass %) | | | | | |
| Z8 | | FEC/EMC | — | 85 | 71 | — | — | — |
| | | (20/80) | | | | | | |
| Z9 | LiPF₆ | FEC/EMC | — | 81 | x | — | — | — |
| | (1.0 mol/L) | (20/80) | | | | | | |
| | LiBF₄ | | | | | | | |
| | (0.2 mol/L) | | | | | | | |
| Z10 | LiPF₆ | FEC/MP | — | x | x | — | — | — |
| | (1.0 mol/L) | (5/95) | | | | | | |

Note:
EC: ethylene carbonate
EMC: ethyl methyl carbonate
PC: propylene carbonate
DMC: dimethyl carbonate
MA: methyl acetate
FEC: 4-fluoroethylene carbonate
EA: ethyl acetate
MP: methyl propionate
VC: vinylene carbonate
VEC: vinyl ethylene carbonate
x: Battery whose capacity retention ratio fell below 70% before the end of the cycle test.

### [Analysis about Battery Performance up to 200 Cycles]

The results shown in Tables 5 to 8 clearly demonstrate the following. Each of Batteries A1 to A27 of the invention contains the chain carboxylic ester(s) and FEC as the solvents of the electrolyte solution, while Comparative Batteries Z1 and Z2 contain, as the solvent of the electrolyte solution, a mixture of EC and EMC, and a mixture of EC, PC, and DMC, respectively, and Comparative Batteries Z8 and Z9 contain FEC and EMC (i.e., the solvent comprises fluorine-substituted carbonate and chain carbonic ester). When comparing between these batteries, Batteries A1 to A27 of the invention exhibited improved capacity retention ratios over Comparative Batteries Z1, Z2, Z8, and Z9. The reason is believed to be as follows. In Comparative Batteries Z1, Z2, Z8, Z9, which do not contain chain carboxylic esters as the solvent of the electrolyte solution, the permeability of the electrolyte solution becomes insufficient under the circumstances in which the loading amount of the active material to the electrode plate is large or the filling density of the active material to the electrode plate is high, and lithium ion diffusion is difficult to take place, so the reaction becomes non-uniform, accelerating battery deterioration. In contrast, in Batteries A1 to A27 of the invention, which contain the chain carboxylic esters as the solvent of the electrolyte solution, good permeability of the electrolyte solution is ensured even under the circumstances in which the loading amount of the active material to the electrode plate is large or the filling density of the active material to the electrode plate is high, and lithium ion diffusion takes place sufficiently. Therefore, non-uniform reaction is prevented, and battery deterioration can be inhibited.

In addition, good capacity retention ratios as obtained by Batteries A1 to A27 of the invention, in which the solvent of the electrolyte solution contains a chain carboxylic ester and FEC is added thereto, were not exhibited by Comparative Batteries Z3 and Z4, in which the solvent of the electrolyte solution comprises chain carboxylic ester and addition agents added thereto, nor Comparative Batteries Z5 to Z7, in which the solvent of the electrolyte solution comprises chain carboxylic ester and EC. Judging from the results of the foregoing experiment 1, it is believed that although load characteristics improve when the solvent of the electrolyte solution contains a chain carboxylic ester as in Comparative Batteries Z3 to Z7, the reaction between the negative electrode active material and the chain carboxylic ester is not prevented sufficiently when the solvent of the electrolyte solution merely contains a chain carboxylic ester, so battery deterioration takes place at an early stage.

The results of Comparative Batteries Z3 to Z7, in which the solvent of the electrolyte solution contains a chain carboxylic ester, demonstrate that merely adding a chain carboxylic ester to the solvent of the electrolyte solution as in the conventional techniques does not improve battery durability but rather becomes a cause of degradation in battery durability, since chain carboxylic esters have high reactivity with the negative electrode active material. In contrast, as in the present invention, when FEC is used as the solvent of the electrolyte solution in addition to chain carboxylic ester, FEC serves to inhibit the reaction between the chain carboxylic ester and the negative electrode active material, and moreover, the viscosity lowering effect of the chain carboxylic ester on the electrolyte solution, which is the advantage of the chain carboxylic ester, can be maximized. Therefore, both good load characteristics and durability can be achieved.

Nevertheless, even when FEC is used as a solvent of the electrolyte solution in addition to chain carboxylic ester, the cycle performance will not improve if the amount of FEC with respect to the total amount of the solvent is 5 volume %, as in the case of Comparative Battery Z10. In contrast, Batteries A15 to A19 of the invention, in which the same solvent as that of Comparative Battery Z10 is used but the amount of FEC with respect to the total amount of the solvent is 10 volume % or higher, exhibit significant improvements in cycle performance. The reason is believed to be as follows. In Comparative Battery Z10, the amount of FEC is so small that the reaction between the chain carboxylic ester and the negative electrode active material cannot be inhibited sufficiently. In contrast, in Battery A15 to A19 of the invention, the amount of FEC is enough to sufficiently inhibit the reaction between the chain carboxylic ester and the negative electrode active material. Therefore, it is believed that the amount of FEC with respect to the total amount of the solvent must be restricted to 7 volume % or greater. From the results of the experiment for Batteries A15 to A19 of the invention, it is desirable that the amount of FEC with respect to the total amount of the solvent be from 10 volume % to 50 volume %, and more desirably from 20 volume % to 40 volume %.

In addition, as seen from Tables 1 and 2 above, Batteries A9 to A11 of the invention, which contain LiBF₄, show lower discharge capacities than Battery A1 of the invention, which does not contain LiBF₄. The reason is believed to be that in Batteries A9 to A11 of the invention, which contain LiBF₄, LiBF₄ is involved in the formation of the negative electrode surface film during the initial charge. However, in terms of cycle performance as seen from Tables 5 and 6, Batteries A9 to A11, which contain LiBF₄, exhibited further improvements in the capacity retention ratio over Battery A1, which does not contain LiBF₄. Probably, since LiBF₄ in addition to FEC is involved in the formation of the negative electrode surface film, the surface film is formed in a better condition than when no LiBF₄ is added, and the decomposition of the chain carboxylic ester is inhibited further. From this viewpoint, it is more preferable that LiBF₄ is added in the electrolyte solution according to the invention, which contains a chain carboxylic ester and FEC. This is also clear from the comparison between Battery A13 and Battery A14, and the comparison between Battery A16 and Battery A20 (note that in this case, although Battery A20 shows a poorer capacity retention ratio at the 100th cycle but a better capacity retention ratio at the 200th cycle than Battery A16). Furthermore, as clearly seen from the result for Battery A12 of the invention, the lithium salt that achieves such an advantageous effect is not limited to LiBF₄ but may be LiB(C₂O₄)₂.

It was also confirmed that the electrolyte solution that does not use FEC but uses LiBF₄ alone could not inhibit the decomposition of the chain carboxylic ester. Therefore, needless to say, it is essential to mix FEC in the electrolyte solution.

### [Analysis about Battery Performance up to 500 Cycles]

Analysis about Types of Solvents

Batteries A1, A13, A16, and A21 to A23 of the invention are similar in the respect that the solvent contains FEC and LiPF₆ is added at 1 mol/L. However, Battery A16, in which the solvent other than FEC is MP, exhibited better cycle performance than Batteries A1, A13, and A21 to A23, in which the solvents other than FEC are MA, EA, n-PA, i-PA, and EP, respectively. To study why such results of the experiment resulted, the conductivities at room temperature of the electrolyte solutions used for the respective batteries were measured. The results are shown in Table 9 below.

TABLE 9

| | Solvent | Additive agent | Conductivity at 25° C. |
|---|---|---|---|
| Battery | (Volume ratio) | (Amount added) | (mS/cm) |
| A1 | FEC/MA | — | 21.3 |
| | (20/80) | | |
| A13 | FEC/EA | — | 15.3 |
| | (20/80) | | |
| A16 | FEC/MP | — | 14.4 |
| | (20/80) | | |
| A21 | FEC/n-PA | — | 10.7 |
| | (20/80) | | |
| A22 | FEC/i-PA | — | 10.9 |
| | (20/80) | | |
| A23 | FEC/EP | — | 11.3 |
| | (20/80) | | |
| A24 | FEC/n-MB | — | 9.9 |
| | (20/80) | | |
| Z1 | EC/EMC | VC | 9.3 |
| | (30/70) | (2 mass %) | |

Note:
FEC: 4-fluoroethylene carbonate
MA: methyl acetate
EA: ethyl acetate
MP: methyl propionate
n-PA: n-propyl acetate
i-PA: i-propyl acetate
EP: ethyl propionate
n-MB: methyl n-butyrate
EMC: ethyl methyl carbonate

As clearly seen from Table 9, the electrolyte solution containing MA, which has the lowest viscosity, in addition to FEC shows the highest conductivity, and the electrolyte solution containing EA shows the second highest, followed by the electrolyte solution containing MP. Judging from this fact alone, MA and EA should be superior to MP in terms of lithium ion diffusion. However, Battery A16, which used MP in addition to FEC as the solvent, exhibits exceptionally good cycle performance.

Although the reason is not clear, it is believed that since MP has the lowest reactivity with the negative electrode among the chain carboxylic esters, the battery using the electrolyte solution containing MP produces a good result in the cycle test over a long period, unlike the ranking order of conductivity shown in Table 9 above. Of course, it is clear from the result for Comparative Battery Z7 that the electrolyte solution that does not contain FEC is unable to yield good cycle performance even when the electrolyte solution contains MP.

Analysis about Additive Agents

Batteries A1 and A13 of the invention use electrolyte solutions respectively containing MA and EA, which have high conductivities. These batteries showed capacity degradation, which is believed to be due to their reactivity with the negative electrode, at a late stage of cycling. Battery A13, which used EA, especially showed significant capacity degradation at a late stage of cycling. It was observed that the deterioration of the capacity retention ratio was inhibited in Batteries A10 and A14 of the invention, which used electrolyte solutions additionally containing LiBF₄, even after the repeated charge-discharge cycles, and that advantageous effect was especially noticeable in Battery A14, which used an electrolyte solution containing EA. In addition, when comparing between Battery A16 and Battery A20 of the invention, which use electrolyte solutions containing MP, Battery A20, which contained LiBF₄, could inhibit the deterioration of capacity retention ratio more effectively than Battery A16, which did not contain LiBF₄. This is believed to be because a surface film is firmly formed on the negative electrode by adding LiBF₄ to the electrolyte solution, and as a result, the reactivity between the chain carboxylic ester and the negative electrode is suppressed more effectively.

Note that as clearly seen from the results shown in Table 8 for Comparative Batteries Z8 and Z9, no improvement in capacity retention ratio was observed even when LiBF₄ was mixed with the conventional electrolyte solutions. Therefore, it is believed that the improvement in the capacity retention ratio is a phenomenon unique to the battery using an electrolyte solution containing FEC and a chain carboxylic ester.

As has been discussed above, it becomes possible to obtain a non-aqueous electrolyte secondary battery that can ensure sufficient permeability of electrolyte solution and that have high capacity, high power, and high durability at the same time by using a non-aqueous electrolyte solution that contains, in the solvent, 4-fluoroethylene carbonate and a chain carboxylic ester represented by the formula R₁COOR₂, where R₁ and R₂ are alkyl groups having 3 or less carbon atoms and restricting the amount of the 4-fluoroethylene carbonate.

### Experiment 3

The conductivities at 25° C. of the following various electrolyte solutions were measured, and also the conductivities thereof at −20° C. (which were measured after they were set aside for 2 hours in a thermostatic chamber kept at −20° C.) were measured. The results are shown in Table 10. In Table 10, electrolyte solutions b1 to b4 are the electrolyte solutions used in the present invention, and the electrolyte solutions y1 and y2 are conventional electrolyte solutions.

TABLE 10

| | | | | Conductivity | Conductivity at |
|---|---|---|---|---|---|
| Electrolyte | Solvent | Additive agent | Battery using | at 25° C. | −20° C. |
| solution | (Volume ratio) | (Amount added) | the electrolyte | (mS/cm) | (mS/cm) |
| b1 | FEC/MP | — | A16 | 14.3 | 6.8 |
| | (20/80) | | | | |
| b2 | FEC/DMC/MP | — | A27 | 13.5 | 6.0 |
| | (20/20/60) | | | | |
| b3 | FEC/DMC/MP | — | A26 | 12.6 | 5.2 |
| | (20/40/40) | | | | |
| b4 | FEC/DMC/MP | — | A25 | 11.6 | 4.4 |
| | (20/60/20) | | | | |
| y1 | FEC/DMC | — | — | 10.4 | 1.7 |
| | (20/80) | | | | |
| y2 | EC/EMC | VC | Z1 | 9.3 | 2.7 |
| | (30/70) | (2 mass %) | | | |

Note:
FEC: 4-fluoroethylene carbonate,
MP: methyl propionate
DMC: dimethyl carbonate
EMC: ethyl methyl carbonate

As clearly seen from Table 10, while the electrolyte solution y1, which does not contain chain carboxylic ester but contains DMC with a high melting point, shows an extremely low conductivity at a low temperature, the electrolyte solutions b1 to b4, which contain chain carboxylic esters regardless of whether DMC is contained, show high conductivities even at a low temperature. From the results, it is understood that the electrolyte solution needs to contain a chain carboxylic ester in order to lower the viscosity of the electrolyte solution and to obtain a high conductivity over a wide temperature range. Moreover, from the comparison among the electrolyte solutions b1 to b4, it is desirable that the amount of the chain carboxylic ester be 20 volume % or greater, more desirably 40 volume % or greater, with respect to the total amount of the solvent.

### SECOND GROUP OF EXAMPLES

### Example C1

### Preparation of Positive Electrode

The positive electrode slurry prepared in the same manner as described in the foregoing embodiment was applied onto both sides of an aluminum foil current collector in an amount of 360 g/10 cm², and then dried. Thereafter, the resultant material was pressure-rolled so that the positive electrode filling density became 3.6 g/cc. Thus, a positive electrode was prepared.

### Preparation of Negative Electrode

The negative electrode slurry prepared in the same manner as described in the foregoing preferred embodiment was applied onto both sides of a copper foil current collector in an amount of 160 g/10 cm², and then dried. Thereafter, the resultant material was pressure-rolled so that the negative electrode filling density became 1.6 g/cc. Thus, a negative electrode was prepared.

### Preparation of Electrolyte Solution

4-fluoroethylene carbonate (FEC) and methyl propionate [C₂H₅COOCH₃] were mixed at a volume ratio of 20:80, and LiPF₆ as an electrolyte was dissolved into the solvent at a concentration of 1 mole/L. Thus, a non-aqueous electrolyte solution was prepared.

### Preparation of Battery

The positive electrode and the negative electrode prepared in the above-described manner were cut into predetermined dimensions, and coiled around so as to oppose each other with a polyethylene separator interposed therebetween. Then, the resultant material was pressed into substantially a flat plate shape. Next, the substantially flat plate-shaped wound assembly was enclosed into a bag-like battery case made of a laminated material of layers of PET and aluminum. Thereafter, the electrolyte solution was filled in the battery case, and the opening of the battery case was heat-sealed. Thus, a non-aqueous electrolyte secondary battery was fabricated.

The non-aqueous electrolyte secondary battery fabricated in this manner is hereinafter referred to as Battery C1 of the invention.

### Example C2

A non-aqueous electrolyte secondary battery was fabricated in the same manner as described in Example C1, except that the loading amount of the positive electrode slurry was set at 290 g/10 cm².

The non-aqueous electrolyte secondary battery fabricated in this manner is hereinafter referred to as Battery C2 of the invention.

### Comparative Example X1

A non-aqueous electrolyte secondary battery was fabricated in the same manner as described in Example C1, except that the solvent used was a mixture of 4-fluoroethylene carbonate (FEC) and ethyl methyl carbonate (EMC) in a volume ratio of 20:80.

The non-aqueous electrolyte secondary battery fabricated in this manner is hereinafter referred to as Comparative Battery X1.

### Comparative Example X2

A non-aqueous electrolyte secondary battery was fabricated in the same manner as described in Example C2, except that the solvent used was a mixture of 4-fluoroethylene carbonate (FEC) and ethyl methyl carbonate (EMC) in a volume ratio of 20:80.

The non-aqueous electrolyte secondary battery fabricated in this manner is hereinafter referred to as Comparative Battery X2.

### Experiment

The above-described Batteries C1 and C2 of the invention and Comparative Batteries X1 and X2 were cycled under the charge-discharge conditions set forth below to find the high-temperature storage performance of each battery. The results are shown in Table 11 below.

a. Charge Conditions for the First Cycle

Each of the batteries was charged at a constant current of 1.0It to a predetermined end-of-charge voltage (to an end-of-charge voltage of 4.2 V [the positive electrode potential being about 4.3 V] for the batteries with a positive electrode loading amount of 360 g/10 cm², and to an end-of-charge voltage of 4.4 V [the positive electrode potential being about 4.5 V] for the batteries with a positive electrode loading amount of 290 g/10 cm²), and further charged at a predetermined constant voltage (4.2 V or 4.4 V) until the current value reached 0.05It.

b. Discharge Conditions

The batteries were discharged at a current rate of 1.0It until the battery voltage reached 2.75 V.

c. Charge Conditions for the Second Cycle

The batteries were charged under the same charge conditions as in the first cycle.

d. Disassembling of Battery

After the charge in the second cycle, each of the batteries was disassembled and only the positive electrode was taken out. Then, the positive electrode and the corresponding electrolyte solution were again enclosed in the laminate battery case.

e. Storage Conditions

Each of the positive electrodes enclosed in the battery case was stored at 60° C. for 10 days.

TABLE 11

| | | | | Thickness |
|---|---|---|---|---|
| | Lithium salt | Solvent | Battery voltage | increase |
| Battery | (content) | (volume ratio) | (V) | (mm) |
| C1 | LiPF₆ | FEC/MP | 4.2 | 1.1 |
| | (1.0 mol/L) | (20/80) | | |
| X1 | | FEC/EMC | | 1.4 |
| | | (20/80) | | |
| C2 | | FEC/MP | 4.4 | 7.9 |
| | | (20/80) | | |
| X2 | | FEC/EMC | | 6.3 |
| | | (20/80) | | |

Note:
FEC: 4-fluoroethylene carbonate,
MP: methyl propionate
EMC: ethyl methyl carbonate

### Results

As clearly seen from Table 11, the amount of gas generated was increased in both the comparative batteries and the batteries of the invention when the battery charge voltage was raised from 4.2 V to 4.4 V. When comparing between Battery C1 of the invention and Comparative Battery X1, both of which had an end-of-charge voltage of 4.2 V, Battery C1 of the invention exhibited a less thickness increase than Comparative Battery X1. On the other hand, when comparing between Battery C2 of the invention and Comparative Battery X2, both of which had an end-of-charge voltage of 4.4 V, Battery C2 of the invention showed a greater thickness increase than Comparative Battery X2.

The reason is believed to be as follows. When the positive electrode potential is 4.5 V (the end-of-charge voltage: 4.4 V) or higher, the chain carboxylic ester decomposes at the positive electrode, and therefore, the amount of gas generated increases. From the results, it is confirmed that the positive electrode potential in a fully charged state should preferably be restricted to less than 4.5 V in the battery according to the present invention.

The present invention is applicable to driving power sources for mobile information terminals such as mobile telephones, notebook computers, and PDAs, as well as to drive power sources for, for example, power tools, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A non-aqueous electrolyte solution for a secondary battery, comprising:
a solvent; and
an electrolyte containing a lithium salt, wherein
the solvent contains 4-fluoroethylene carbonate and a chain carboxylic ester represented by the formula R₁COOR₂, where R₁ and R₂ are alkyl groups having 3 or less carbon atoms, and the amount of the 4-fluoroethylene carbonate is 7 volume % or greater with respect to the total amount of the solvent.

2. The non-aqueous secondary battery electrolyte solution according to claim 1, wherein the chain carboxylic ester is at least one chain carboxylic ester selected from the group consisting of methyl acetate [CH₃COOCH₃], ethyl acetate [CH₃COOC₂H₅], methyl propionate [C₂H₅COOCH₃], n-propyl acetate [CH₃COOCH₂CH₂CH₃], i-propyl acetate [CH₃COOCH(CH₃)CH₃], ethyl propionate [C₂H₅COOC₂H₅], methyl n-butyrate [CH₃CH₂CH₂COOCH₃], and methyl i-butyrate [CH₃(CH₃)CHCOOCH₃].

3. The non-aqueous secondary battery electrolyte solution according to claim 1, wherein the chain carboxylic ester comprises at least one chain carboxylic ester selected from the group consisting of methyl acetate [CH₃COOCH₃], ethyl acetate [CH₃COOC₂H₅], and methyl propionate [C₂H₅COOCH₃].

4. The non-aqueous secondary battery electrolyte solution according to claim 1, wherein the chain carboxylic ester contains methyl propionate [C₂H₅COOCH₃].

5. The non-aqueous secondary battery electrolyte solution according to claim 1, wherein the amount of the chain carboxylic ester is 20 volume % or greater with respect to the total amount of the solvent.

6. The non-aqueous secondary battery electrolyte solution according to claim 3, wherein the amount of the chain carboxylic ester is 20 volume % or greater with respect to the total amount of the solvent.

7. The non-aqueous secondary battery electrolyte solution according to claim 5, wherein the amount of the chain carboxylic ester is 40 volume % or greater with respect to the total amount of the solvent.

8. The non-aqueous secondary battery electrolyte solution according to claim 1, wherein the amount of the 4-fluoroethylene carbonate is from 10 volume % to 50 volume % with respect to the total amount of the solvent.

9. The non-aqueous secondary battery electrolyte solution according to claim 3, wherein the amount of the 4-fluoroethylene carbonate is from 10 volume % to 50 volume % with respect to the total amount of the solvent.

10. The non-aqueous secondary battery electrolyte solution according to claim 8, wherein the amount of the 4-fluoroethylene carbonate is from 20 volume % to 40 volume % with respect to the total amount of the solvent.

11. The non-aqueous secondary battery electrolyte solution according to claim 1, wherein the electrolyte contains LiBF₄.

12. The non-aqueous secondary battery electrolyte solution according to claim 11, wherein the concentration of the LiBF₄ is within a range of from 0.05 mol/L to 0.6 mol/L.

13. The non-aqueous secondary battery electrolyte solution according to claim 1, wherein the solvent contains vinylene carbonate.

14. The non-aqueous secondary battery electrolyte solution according to claim 1, wherein the solvent contains vinyl ethylene carbonate.

15. A non-aqueous electrolyte secondary battery comprising: a positive electrode; a negative electrode; a separator; and a non-aqueous secondary battery electrolyte solution according to claim 1.

16. A non-aqueous electrolyte secondary battery comprising: a positive electrode; a negative electrode; a separator; and a non-aqueous secondary battery electrolyte solution according to claim 3.

17. The non-aqueous electrolyte secondary battery according to claim 15, wherein the positive electrode in a fully charged state has a potential of less than 4.5 V versus metallic lithium.

18. The non-aqueous electrolyte secondary battery according to claim 16, wherein the positive electrode in a fully charged state has a potential of less than 4.5 V versus metallic lithium.

19. The non-aqueous electrolyte secondary battery according to claim 15, wherein: the positive electrode further comprises a positive electrode active material; the positive electrode active material contains lithium cobalt oxide containing aluminum or magnesium in solid solution; and zirconium is firmly adhered to the surface of the lithium cobalt oxide.

20. The non-aqueous electrolyte secondary battery according to claim 16, wherein: the positive electrode further comprises a positive electrode active material; the positive electrode active material contains lithium cobalt oxide containing aluminum or magnesium in solid solution; and zirconium is firmly adhered to the surface of the lithium cobalt oxide.
